(19) United States
(12) Patent Application Publication
(10) Pub. No.: US 2026/0195902 A1
(43) Pub. Date: Jul. 9, 2026

(54) Layered Disparity Representation and Active Neurons for Enhanced Depth Perception, Border Ownership Generation, and Surface Filling-In

(71) Applicant: Tianlong Chen, Germantown, MD (US)

(72) Inventor: Tianlong Chen, Germantown, MD (US)

(21) Appl. No.: 19/312,316

(22) Filed: Aug. 28, 2025

Related U.S. Application Data
(60) Provisional application No. 63/743,604, filed on Jan. 9, 2025.

(51) Int. Cl. G06T 7/194; G06T 7/149; G06T 7/181; G06T 7/187; G06T 7/20; G06T 7/593

(52) U.S. Cl. CPC G06T 7/194; G06T 7/149; G06T 7/181; G06T 7/187; G06T 7/20; G06T 7/593; G06T 2207/20084

(57) ABSTRACT

The invention relates to methods and systems for visual depth representation and segmentation in image and vision processing. A layered representation is introduced that includes near disparities, far disparities expressed in logarithmic form to flatten the magnitude difference between small and large disparities, and optionally additional disparity types. The framework may also incorporate optic flow channels to encode motion cues. The invention further provides active neurons that propagate border ownership signals along contours, extend ownership into surfaces, and preserve object identity. By combining disparity, border ownership, and active neuron modules, the invention enables efficient figure-ground organization and segmentation across diverse vision tasks.

### CROSS-REFERENCE TO RELATED APPLICATIONS

This application claims the benefit of U.S. Provisional Patent Application No. 63/743,604, filed on Jan. 9, 2025, entitled “Layered Disparity Representation and Active Neurons for Enhanced Depth Perception, Border Ownership Generation, and Surface Filling-In”, the entire contents of which are hereby incorporated by reference.

### FIELD OF THE INVENTION

The present invention relates to image and vision processing. More particularly, the invention concerns methods and systems for representing visual depth through disparity mappings, including logarithmic mappings for far-distance disparities and layered disparity representations across multiple depth ranges. The invention further relates to the generation of border ownership using disparity and motion cues, including optic flow information. The invention also relates to mechanisms for surface filling-in using active neurons, and to integrated models for border ownership-centered segmentation that provide figure-ground organization, incorporate depth and motion representations, and enable object pointer generation.

### BACKGROUND OF THE INVENTION

Accurate object segmentation, depth perception, and motion analysis are critical tasks in computer vision and image processing. Conventional approaches rely heavily on region-based segmentation techniques, such as Mask R-CNN, basic disparity estimation, and simple motion tracking. These methods fail to capture the complexity of real-world visual scenes, particularly where objects are distributed across large depth ranges or involve dynamic motion. Existing disparity models are primarily limited to near-distance disparities, and motion cues such as optic flow are often handled independently, without integration into a unified framework.

The concept of layered disparity representation offers a more nuanced framework by distinguishing among different disparity types. While prior work has described methods for processing near-distance disparities and for channeling optic flow separately, the use of far-distance disparities in logarithmic form, and the integration of near and far disparities with motion cues into a unified layered representation, have not been adequately addressed in the art. This invention introduces a layered disparity representation that combines near-distance and far-distance disparity mappings with optic flow information, providing a scalable depth-and-motion encoding that enhances accuracy across multiple ranges.

Prior border ownership generation methods have not effectively incorporated depth or motion information. Traditional approaches based solely on contour cues are insufficient for complex environments involving multiple depth layers or dynamic motion parallax. The present invention enhances border ownership generation by integrating layered disparity and motion cues with contour-based information, thereby enabling accurate figure-ground determination even in cluttered or dynamic scenes.

Similarly, surface filling-in has typically been treated as a separate post-processing step, often requiring iterative region-growing techniques or external feedback. While contour-based border ownership generation identifies object boundaries, it does not alone provide complete segmentation of object interiors. State-of-the-art region-based approaches, such as Mask R-CNN, effectively act as surface filling-in mechanisms but lack explicit border ownership and depth-motion integration. In contrast, the present invention integrates layered disparity and motion cues with active neurons that propagate ownership signals from contours into object interiors. This mechanism ensures consistent labeling and efficient surface filling-in with short latency, thereby enabling accurate and biologically inspired segmentation.

Beyond border ownership generation and surface filling-in, the layered disparity and motion representation of the present invention can also be extended to other vision tasks, including advanced motion analysis, object recognition, and 3D scene reconstruction, offering a generalizable framework for image and vision processing systems.

### SUMMARY OF THE INVENTION

The present invention introduces methods and systems for layered disparity representation and active neuron-based processing in vision systems. The invention integrates disparity, motion cues, border ownership, and surface filling-in into a unified framework for accurate figure-ground segmentation and scene understanding. Key components of the invention include:

Logarithmic Far-Distance Disparity: The invention provides a logarithmic mapping for far-distance disparities that flattens the magnitude difference between small and large disparities, thereby enabling scalable and accurate depth perception across wide distance ranges.

Layered Disparity Representation with Motion Cues: A layered approach is introduced that combines near-distance disparities, far-distance disparities, and, in some embodiments, other disparity types, into separate channels. These channels can be further integrated with optic flow layers to jointly represent depth and motion, providing a richer encoding for scene analysis.

Border Ownership Generation with Layered Disparity and Motion: The invention enhances border ownership generation by incorporating layered disparity and motion cues as inputs to contour-based processing. This enables robust determination of figure-ground relationships even in cluttered or dynamic visual scenes.

Active Neurons for Surface Filling-In: The invention introduces active neurons as computational units that propagate ownership signals from borders into surface regions, assess similarity with neighboring units, and maintain object identity. This enables fast, efficient, and consistent surface filling-in with short latency.

Integrated System for Border Ownership-Centered Segmentation: By combining disparity modules, border ownership modules, and active neuron modules, the invention provides an integrated system for unified figure-ground segmentation. The system supports applications in general vision tasks, including depth-based object recognition, motion analysis, scene understanding, and 3D reconstruction.

These innovations enable the generation of accurate instance masks, panoptic masks, and depth-aware scene representations, making the invention applicable across a wide range of vision systems, including robotics, autonomous vehicles, augmented reality, and virtual reality.

### BRIEF DESCRIPTION OF THE DRAWINGS

Exemplary embodiments of the present disclosure are shown in the drawings and will be explained in detail in the description that follows.

FIG. 1 is a schematic diagram of Epipolar geometry for two observers at locations O_{L} and O_{R} observing an object point P.

FIG. 2 is a list of images illustrating a binocular example from the photorealistic Virtual Kitti dataset (referred to as contrast-defined images in which objects are called ‘contrast-defined’ objects), resembling real-world scenario. The first two images show binocular views (left 2001 and right 2003), followed by a 3^{rd} image 2005 that is a stereo anaglyph created from these binocular images; the 4^{th} image 2007 displays a 2-channel border ownership coding map, where red-colored occluding segments indicate their owner sides are ‘left’ or ‘bottom’, and green-colored occluding segments indicate their owner sides are ‘right’ or ‘above’ (the color coding for ownership is the same as that in the paper by Chen. et al., (2022) The Inventor was the first author of that paper); the 5^{th} image 2009 shows the (1-channel) Epipolar disparity map (also referred to as ‘Near disparity’), where lighter red indicates greater distances with smaller disparities and darker red represents closer distances with larger disparities (This color coding applies to all the disparity maps herein); and the 6^{th} image 2011 presents the (1-channel) logarithmic form (also referred to as ‘Far disparity) of the Epipolar disparity image.

FIG. 3 is similar to FIG. 2 but illustrates a binocular Random Dot Stereogram (RDS) example (referred to as disparity-defined images in which objects are called ‘disparity-defined’ objects). The top two images show binocular views (left 3001 and right 3003), where the left image is a pure random dot image, and the right image is created by shifting a few rectangular areas in the left image. When viewed by two eyes respectively, these shifted areas appear to pop up as rectangular objects (referred to as ‘disparity-defined objects’, whereas the objects in FIG. 2 are referred to as ‘contrast-defined objects’). The middle-left image 3009 displays a disparity map of (shifted areas) (′Near disparity); the middle-right image 3011 is the logarithmic form (‘Far disparity’) of the disparity map. The bottom-left image 3007 presents a 2-channel border ownership map (the color coding is the same as in FIG. 2), and the bottom-right image 3005 shows a stereo anaglyph created from the top two binocular images 3001, and 3003.

FIG. 4 presents three schematic diagrams illustrating different configurations for binocular border ownership generation with varying levels of disparity involvement. Diagram (a) depicts a configuration without explicit disparity involvement, where the network is expected to learn the disparity information implicitly. Diagram (b) shows a configuration where either ‘Near’, ‘Far’, or both disparities are generated and involved. Diagram (c) illustrates a configuration where both ‘Near’ and ‘Far’ disparities are generated separately and then integrated.

FIG. 5 illustrates an exemplary ‘surface filling-in’ generation (also referred to as ‘surface filling-in’ in neuroscience or ‘instance mask’ in computer vision) for two overlapping rectangular objects (5001 and 5003) with 2-channel border ownership coded borders. The generation process begins at the border ownership contours where pixels (or neurons) along the ‘ownership direction’, and the connected pixels form an object, and an object identity is assigned to the object.

FIG. 6 illustrates an architecture diagram of border ownership-centered segmentation model (or figure-ground organization in neuroscience context).

### DESCRIPTION OF THE PREFERRED EMBODIMENT

Exemplary embodiments of the present invention will now be described with reference to the accompanying drawings.

Layered Disparity Representation: The invention introduces a layered representation where disparities are organized into separate channels for ‘Near’, ‘Far’, and other types of disparities. While ‘Near’ disparity representation is known in prior art, the novel ‘Far’ disparity channel provides a logarithmic depth representation that enhances accuracy at large distances. This layered approach ensures robust depth perception across varying ranges.

The layered representation can be extended to include additional disparities derived from motion parallax or other depth cues. Each channel encodes a specific type of disparity, allowing the system to process and integrate multiple depth cues effectively. This layered approach can be applied to tasks such as:
(1) Border Ownership Generation: Using depth cues to determine figure-ground relationships. The layered disparity channels enhance the ability to distinguish foreground objects from background elements, especially in complex or cluttered scenes.
(2) Surface Filling-In: Propagating ownership signals from border contours into object interiors using active neurons, ensuring complete and accurate object segmentation.
(3) Motion Analysis: Enhancing the accuracy of motion tracking by combining optic flow with layered disparities.
(4) Object Recognition: Improving depth-based object detection and classification.
(5) 3D Scene Reconstruction: Generating detailed 3D models by leveraging depth information across different ranges.

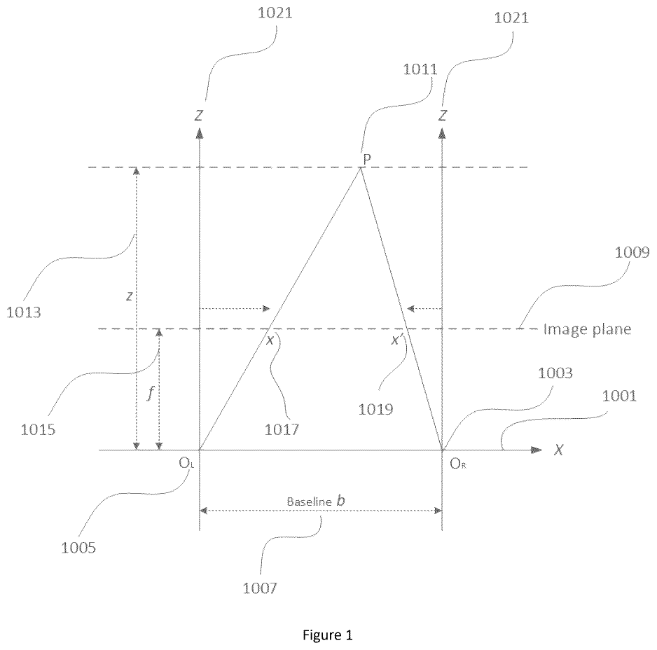

In computer vision, binocular disparity is defined as the difference in the image location of an object point in the left and right eyes (or cameras). According to the Epipolar Geometry of binocular vision, as shown in FIG. 1, the (horizontal) binocular disparity of object point P 1011 is inversely proportional (see (Eq. 1.0) below for two ‘rectified images’) to its depth z (i.e., z=Depth) 1013 of point P 1011 under a simplified and commonly setup condition where the image planes 1009 of both eyes (O_{L}1003, O_{R} 1005) are parallel. Making any two images parallel is called ‘rectification’; the images are called ‘rectified images’.

$$Disparity = x - {x}^{′} = \frac{f * b}{z} = \frac{k}{Depth} \qquad ( Eq . 1. )$$

where x 1017 and x′ 1019 are x-direction viewing coordinates of O_{L}1003, O_{R} 1005 on the image plane 1009, f is the focal length 1015 of the eyes (cameras), b is the distance 1007 (called baseline) between the eyes (cameras), z is the depth 1013 of object point P 1011, and k=f*b, assuming two eyes are looking in z-direction 1021.

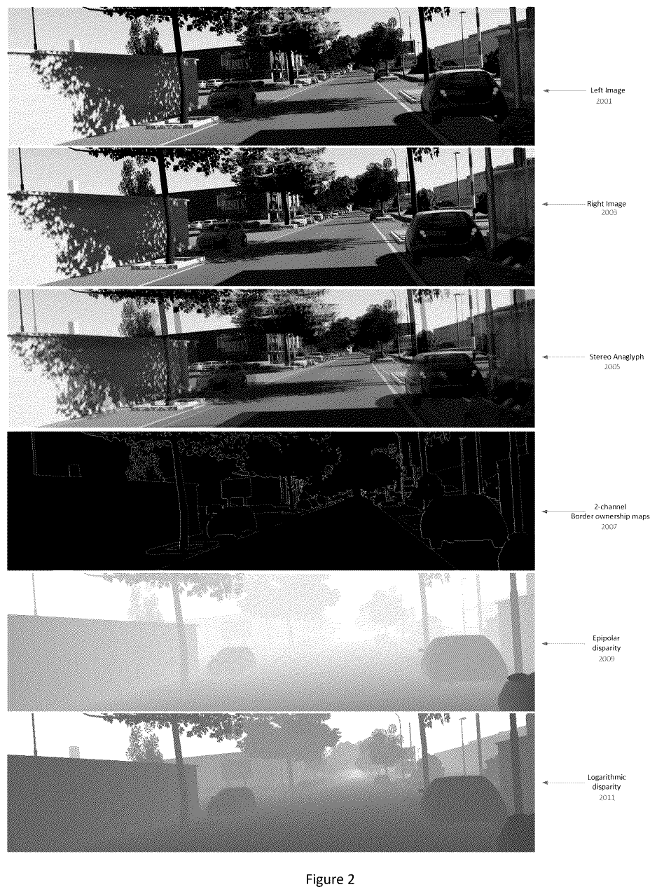

FIG. 2 is an example of a binocular case of regular color images of the left image 2001 and the right image 2003 (referred to as contrast-defined images in which objects are called ‘contrast-defined’ objects), 2005 is the stereo anaglyph of the left 2001 and right 2003 images, 2007 is a 2-channel border ownership map viewed from the left eye (camera) in which red-colored occluding segments have their border owner sides on ‘left’ or ‘below’ and green-colored occluding segments have their border owner sides on ‘left’ and ‘above’ (used the same color coding for 2-channel border ownership as Chen et al., (2022)), 2009 is an Epipolar disparity map of the left 2001 and right 2003 images, following the disparity equation (Eq. 1.0). Theoretically, (Eq. 1.0) can represent the relationship of any depth and disparity as long as the condition in FIG. 1 is met. In practice, (Eq. 1.0) becomes meaningless when the depth is so large that the disparity measure error equals or exceeds the disparity measure itself. The image 2009 in FIG. 2 illustrates this: the disparity ‘fades’ into white noise as depth increases. This effect is especially pronounced when significant depth differences exist between nearby and distant objects, as large disparities overwhelm contributions from small disparities. Therefore, additional disparity representation is needed.

The human eye can smoothly perceive a wide range of depth from close to far distances. Neuroscience evidence suggests the presence of disparity-selective neurons that are sensitive to ‘Far’, ‘Near’, and a few other types of disparities in the V1 vision area, but how they are represented in neurons are unclear. Although, other neuroscience evidence found no clear distinct neuron classes for ‘Far’ and ‘Near’ disparities. Nevertheless, ‘Far’ and ‘Near’ disparities exist, regardless of whether they are generated by different neurons. Accordingly, the Inventor uses the following logarithmic form (Eq. 1.1) of Epipolar disparity (Eq. 1.0) to represent ‘Far’ disparity and defines Epipolar disparity (Eq. 1.0) as ‘Near’ disparity.

$$log ( Disparity ) = C - log ( Depth ) \qquad ( Eq . 1.1 )$$

where C=log(k) is a constant. The image 2011 in FIG. 2 is an example of the logarithmic ‘Far’ disparity of Epipolar disparity 2009 in FIG. 2.

The logarithm form (2011 in FIG. 2) preserves the depth order of all objects and backgrounds at all distances and flattens the magnitude difference between small and large disparities (i.e., long and short depth), maintaining good disparity representation even at large depths. Therefore, a combination of Epipolar ‘Near’ disparity and logarithmic ‘Far’ disparity would be a good candidate as an effective disparity representation covering a wide range of distances from near to far. Both Epipolar ‘Near’ disparity and logarithmic ‘Far’ disparity is considered part of ‘absolute disparities’ in neuroscience.

Although a logarithmic mapping is described as one embodiment for representing far-distance disparities by flattening the magnitude difference between small and large disparities, other non-linear mappings that achieve a similar flattening effect, such as power-law, root, or arctangent functions, may also be employed.

For the purpose of border ownership generation, the relative value of disparity is more important than its absolute value. Consequently, the constants k in (Eq. 1.0) and C in (Eq. 1.1) may be adjusted from their original meanings during neural network training to ensure neither disparity map overwhelms the other.

‘Near’ and ‘Far’ disparities are placed in separate disparity channels (i.e. 2009 and 2011 in FIG. 2 are in separate channels), which are referred herein as ‘layered disparity representation’. The individual channel representation of different disparities provides added flexibility, potentially allowing the inclusion of other disparities or optical flow from motion parallax.

The human vision system has disparity-selective neurons (or sensors) but not direct depth-selective neurons (or sensors), whereas computer vision systems have direct depth sensors available but not disparity sensors. If rearranging (Eq. 1.0) and (Eq. 1.1) respectively as (Eq. 1.0′) and (Eq. 1.1′) below, it is noted that the Disparity and Depth in the equations are equivalent in position.

This equivalency suggests that a similar approach to channel representation for disparities could be used for depth or mixed depth/disparity in computer vision systems.

$$Disparity * Depth = k \qquad ( Eq . 1. ’ )$$

$$log ( Disparity ) + log ( Depth ) = C \qquad ( Eq . 1.1 ’ )$$

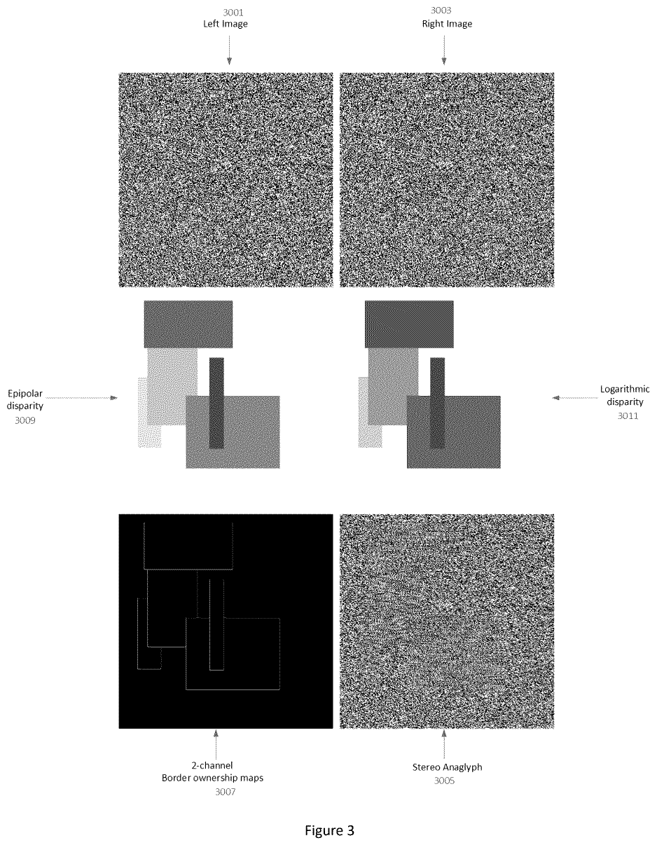

FIG. 3 is a binocular example of Random Dot Stereograms (referred to as ‘disparity-defined’, in which an object is called ‘disparity-defined’ object). The 3009 and 3011 in FIG. 3 are the ‘Near’ and ‘Far’ disparities, respectively, in separate channels.

Border Ownership Generation with Layered Disparity Representation: The layered disparity representation significantly improves border ownership generation by providing richer depth information. By combining ‘Near’ and ‘Far’ disparity channels with optic flows, the system accurately determines which side of a contour belongs to the foreground object. This method ensures robust performance even in scenarios involving large depth variations or dynamic motion.

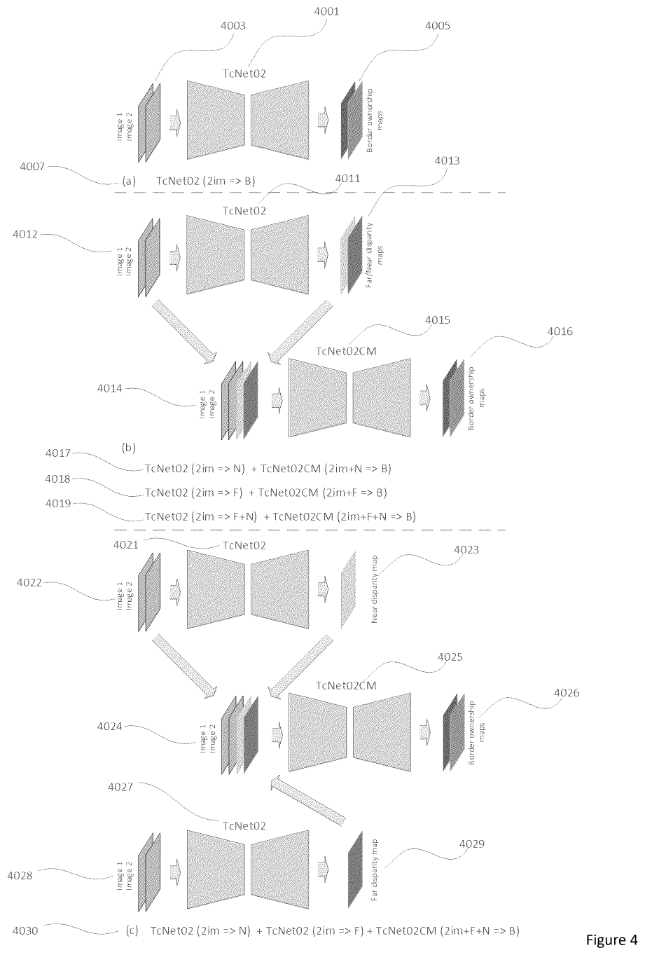

Neuroscience evidence suggests that disparity selective neurons were found to be involved in binocular border ownership generation, but how disparities are involved in border ownership generation is unclear. Chen et al. (2022) describe an encoder-decoder network for border ownership generation, TcNet. The simplest method to extend the functionality of TcNet to generate border ownership with disparity is to stack the binocular images with disparity maps to input into TcNet as illustrated in FIG. 4.

The border ownership coding method described in Chen et al. (2022) applies to both monocular and binocular images. The example datasets demonstrated in the paper uses monocular image input for TcNet, however, the TcNet could be applied to use binocular image inputs, and stacked binocular input with disparity maps. To simplify the description, a monocular image input TcNet is herein referred to as TcNet01, a binocular image input TcNet as TcNet02, and a binocular image input TcNet together with disparity maps as TcNet02CM, as illustrated in FIG. 4.

FIGS. 4 (a), (b), and (c) illustrate varying levels of disparity involvement in border ownership generation (optionally with category selective maps).

FIG. 4 (a) 4007 illustrates an architecture that use binocular images as input and generate border ownership (optionally category selective maps) with expectation that the TcNet02 learns disparity implicitly. The notation of “TcNet02(2im=>B)” indicates that binocular images (“2im”) are used as input to TcNet02, which outputs border ownership maps (“B”).

FIG. 4 (b) illustrates a configuration that ‘Near’ or ‘Far’ disparity or both disparities are explicitly generated as intermediate result, then together with binocular images to generate border ownership (optionally with category selective maps). Specifically, the notation of “TcNet02(2im=>N)+TcNet02CM(2im+N=>B)” 4017 indicates that binocular images (“2im”) are used as input to TcNet02, which outputs ‘Near’ disparity (“N”) as intermediate result, then the binocular images and intermediate ‘Near’ disparity together (“2im+N”) are used as input to TcNet02CM, which outputs border ownership maps (“B”). Similarly, in the notation of “TcNet02(2im=>F)+TcNet02CM(2im+F=>B)” 4018, ‘F’ represents ‘Far’ disparity as intermediate result; whereas in the notation of “TcNet02(2im=>N+F)+TcNet02CM(2im+N+F=>B)” 4019, ‘N+F’ represents both ‘Near’ and ‘Far’ disparities as intermediate result, where the ‘Near’ and ‘Far’ disparities are placed in separate channels.

FIG. 4 (c) 4030 illustrates an architecture that is similar to FIG. 4 (b) 4019 with both ‘Near’ and ‘Far’ disparities except that the ‘Near’ and ‘Far’ disparities are generated separately (4023, 4029) in FIG. 4 (c) 4030.

TcNet02 and TcNet02CM are almost identical except that the inputs are different. Though almost same architecture TcNet02 and TcNet02CM are used to generate disparity and border ownership, it is convenient but not strictly necessary.

Though FIG. 4 illustrates architectures to generate border ownership with ‘Near’ or ‘Far’ disparities, it is applicable to include other disparities and optic flow. Optic flow maps are often represented as two ‘vertical’ and ‘horizontal’ channels, making them naturally fit into the architectures illustrated in FIG. 4 to generate border ownership with motion cues (Optic flow) with optionally with ‘Near’, ‘Far’ and other types of disparities.

Contour-based border ownership generation represents only half the process required for complete segmentation. While it establishes a foundational structure by identifying object boundaries, it must be complemented by ‘surface filling-in’ to determine the interiors of objects—their location and spatial coverage—for complete segmentation.

The Inventor presents a framework for processing ‘surface filling-in’ based on border ownership maps. The purpose of ‘surface filling-in’ is to assign each pixel (its ownership) to an object or the background.

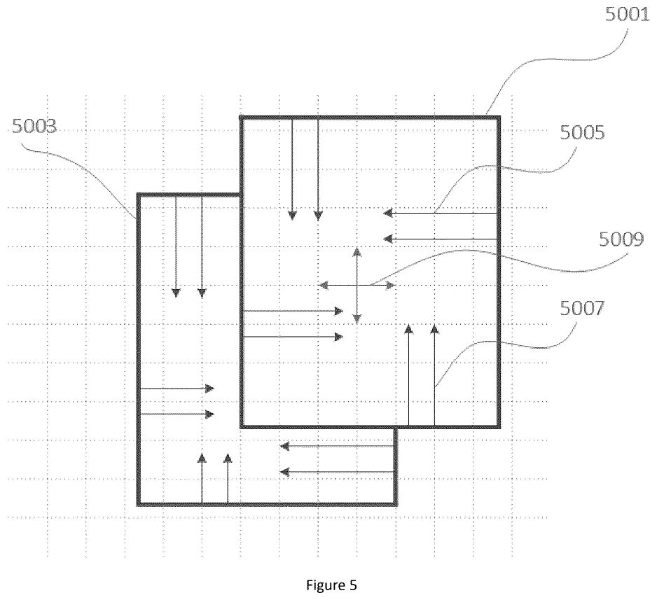

FIG. 5 illustrates an example of two rectangular objects, 5001 and 5003, with their border ownership already generated (FIG. 5 represent a 2-channel border ownership code scheme as example, see Chen et al., 2022). The red-colored contours represent borders with owners on the ‘below’ or ‘left’ sides, while the green-colored contours represent borders with owners on the ‘above’ or ‘right’ sides. The purpose of the ‘surface filling-in’ is to determine the ownership of each pixel, whether it belongs to objects 5001 or 5003, or the background).

To simplify the description, assume each neuron corresponds to a single pixel; for computer vision application, such assumption may be good enough for straightforward implementation but not strictly necessary. The disclosed ‘surface filling-in’ framework begins at each pixel (neuron) along the border ownership contours (as depicted in FIG. 5), propagating ownership signal by connecting (binding) pixels along the ‘owner-side direction’ (5005 and 5007), which is orthogonal to the border ownership contours until they encounter another ownership signal originating from the border ownership contours, or reaching the edge of the image.

Ownership can be resolved as follows: if a red point connects to a green point (or vice versa), they belong to the same object. Conversely, if a green point connects to a green point (or a red point to another red point), they belong to separate objects unless connected from another ‘owner-side direction’. Surface regions are progressively filled by the propagating ownership.

The connected pixels collectively form coherent object regions or background areas, and their identity is assigned with unique identity. The ownership of boundary points—whether on the border ownership contours or at the image edge—is determined based on these connections, ensuring that each region is uniquely identified within the figure-ground organization process.

The simplest implementation involves scanning (pixel by pixel) vertically and horizontally along the ‘owner-side direction’ for the 2-channel border ownership coding maps (FIG. 5). While straightforward, this sequential scanline method would be the slowest approach, necessitating additional mechanisms to meet the ‘short latency’ constraint for border ownership generation.

The most feasible and effective way to shorten processing time is for each neuron to function as an independent, active unit (referred to as ‘active pixel’ or ‘active neuron’). Active neurons independently initiate connection attempts with their neighboring neurons, eliminating the need for sequential processing. This parallel processing approach not only significantly reduces processing time but also align seamlessly with the ‘distributed’ characteristics of border ownership-selective neurons.

In fact, the ‘surface filling-in’ process, which begins at any point along the border ownership contour, inherently suggests that neurons operate with some level of independence. Theoretically, connection initiation is not limited to border neurons-non-border neurons can also initiate connections (as depicted by the ‘blue-colored arrows’ 5009 in FIG. 5). This parallel processing not only accelerates the process but also ensures consistency with the distributed nature of neural processing.

Under ideal, error-free conditions, the implementation of the above framework should be straightforward, requiring no additional cues. However, errors and ambiguities may exist in border ownership maps, other cues can be utilized to influence the decision-making process for initiation and connection. These cues might include disparity maps or feature maps (such as extracted features from the Encoder in TcNet, see Chen et al. 2022). When readily available, these cues can offer additional information to improve accuracy in the ‘surface filling-in’ process, and significantly enhance the robustness of the framework.

Active neurons act as local processing units independently to some extent, while working collaboratively to achieve figure-ground organization (segmentation) at the early vision stage with short latency. They perform the following core functions:
(1) Contour Connection: Neighboring neurons along contours are likely connected, as part of border ownership generation, before the ‘surface filling-in’ process begins, facilitating easier ownership propagation across the surface.
(2) Connection Initiation: Initiate the connection or ‘binding’ process from border ownership contours to propagate ownership;
(3) Object Identity Maintenance: Ensuring consistent labeling of connected pixels within the same object region (or background) as connections propagate or modify.
(4) Similarity Assessment: Evaluate the owner-side direction and similarity with neighboring neurons from available cues, such as disparity maps or feature maps, to refine connections, especially in ambiguous or cluttered regions.

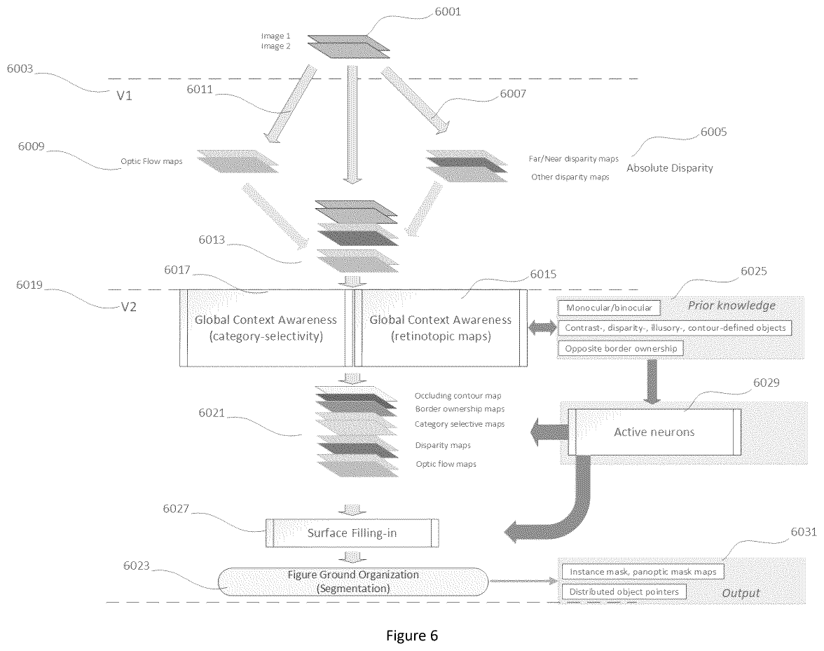

FIG. 6 illustrates an architecture model of border ownership-centered segmentation framework in computer vision context (or figure-ground organization in neuroscience context).

This model integrates multiple types of absolute disparities and motion cues (optic flows). Absolute disparities are generated in the V1 area 6003, and border ownership-centered figure-ground organization is formed in the V2 area 6019. Within this framework, embedded ‘global context awareness’ functions as ‘prior knowledge’, guiding the generation of border ownership with the output of occluding contour maps, border ownership maps, and category-selective maps. These outputs apply across various object types, including contrast-, disparity-, illusory-, and contour-defined objects. Border ownership then directs the ‘surface filling-in’ process, utilizing available cues like disparity or extracted features for effective figure-ground organization. Border ownership-selective neurons in the V2 area operate as distributed ‘active neurons’, responsible for generating border ownership, performing ‘surface filling-in’, and maintaining their persistence.

Referring to FIG. 6, from a computer vision perspective, the proposed channel representation simplifies the integration of diverse inputs and outputs-including RGB images 6001, disparities 6005 (‘Near’, ‘Far’ and other types of disparities), optic flows 6009, contours, border ownership, and category selectivity-throughout the visual processing pipeline from top to bottom. Similar representations may occur in biological vision systems. Using an encoder-decoder neural network, such as TcNet, this model can be trained to embody ‘global context awareness’ and simultaneously generate contour maps, border ownership maps, and category-selective maps 6021. ‘Active pixels (neurons)’ 6029 subsequently generate the ‘object pointers’ (in neuroscience context) or ‘instance masks’ (in computer vision context) required for the figure-ground organization (or object segmentation).

From a computer vision perspective, border ownership generation and surface filling-in are often treated as separate processes. However, in biological vision, both processes may be managed by the same group of neurons, ensuring the persistence of figure-ground organization.

The outputs 6031 of the model for the figure-ground organization correspond to ‘distributed objects’ or ‘distributed object pointers’ from a neuroscience perspective, or ‘instance mask’ or ‘panoptic mask’ maps from a computer vision perspective.

Although the present invention has been described with reference to preferred embodiments, the disclosed invention is not limited to the details thereof, various modifications and substitutions will occur to those of ordinary skill in the art, and all such modifications and substitutions are intended to fall within the spirit and scope of the invention as defined in the appended claims.

What is claimed is:

1. A method for representing far-distance depth in image or vision processing, comprising:
(a) receiving binocular image data;
(b) computing disparities corresponding to visual depth; and
(c) applying a logarithmic mapping to disparities corresponding to far-distance depths so as to flatten the magnitude difference between small and large disparities.

2. The method of claim 1, wherein said mapping comprises a non-linear function that flattens the magnitude difference between small and large disparities.

3. A method for representing depth in image or vision processing, comprising:
(a) receiving binocular image data;
(b) representing near-distance disparities using a mapping consistent with Epipolar geometry;
(c) representing far-distance disparities using a logarithmic disparity mapping; and
(d) combining said near-distance and far-distance disparity representations to form a layered disparity representation across multiple depth ranges.

4. The method of claim 3, wherein said layered disparity representation further includes disparity layers corresponding to additional disparity types different from said near-distance and said far-distance disparities.

5. The method of claim 3, wherein said layered disparity representation is applied to disparity, optic flow, or a combination of disparity and optic flow, to provide a representation of depth, motion, or depth and motion together.

6. The method of claim 3, wherein said layered disparity representation is applied to encode border ownership along contours.

7. The method of claim 3, wherein said layered disparity representation is used to guide surface filling-in through propagation of ownership signals.

8. The method of claim 3, wherein said far-distance disparity channel comprises a non-linear function configured to flatten the magnitude difference between small and large disparities.

9. The method of claim 3, wherein said layered representation is applied to depth data, disparity data or a combination thereof, for layered representation.

10. A system for figure-ground segmentation in image or vision processing, comprising:
(a) a plurality of computational units (“active neurons”) configured to receive disparity or image input;
(b) said active neurons being configured to propagate border ownership signals along connected contours;
(c) said active neurons being further configured to spread ownership signals into surface regions for surface filling-in; and
(d) wherein said active neurons maintain object identity during propagation across contours and surfaces.

11. The system in claim 10, wherein said active neurons connect along contours prior to surface filling-in to support contour completion.

12. The system in claim 10, wherein said active neurons assess similarity with neighboring neurons based on disparity or feature cues to refine surface filling-in.

13. The system in claim 10, wherein said active neurons are configured to propagate ownership signals along owner-side direction.

14. The system in claim 10, wherein said active neurons maintain labeling consistency across surfaces belonging to the same object.

15. A system for visual scene segmentation, comprising:
(a) a disparity module configured to represent depth using a layered disparity representation, said layered disparity representation including Epipolar disparity for near-distance depths and logarithmic disparity for far-distance depths, wherein said logarithmic disparity flattens the magnitude difference between small and large disparities;
(b) a border ownership module configured to generate border ownership;
(c) an active neuron module configured to propagate ownership signals along contours and to perform surface filling-in; and
(d) wherein said disparity module, border ownership module, and active neuron module are integrated to provide a unified figure-ground segmentation of a visual scene.

16. The system of claim 15, wherein said border ownership module directly receives disparity features from said disparity module.

17. The system of claim 15, wherein said active neuron module propagates ownership signals based on outputs of said border ownership module.

18. The system of claim 15, wherein said unified segmentation is generated with short latency by interaction of said disparity module, border ownership module, and active neuron module.

19. The system of claim 15, wherein said layered disparity representation is applied to disparity, optic flow, or a combination of disparity and optic flow, to provide a representation of depth, motion, or depth and motion together.

20. The system of claim 15, wherein said disparity model is further configured to receive depth data, disparity data, or a combination thereof, for layered representation.
